(19) United States
(12) Patent Application Publication
(10) Pub. No.: US 2009/0022090 A1
(43) Pub. Date: Jan. 22, 2009

(54) SWITCHING ALLOCATION IN AD HOC NETWORK

(75) Inventors: Ramy S. Ayoub, Arlington Heights, IL (US); Jeffrey D. Bonta, Arlington Heights, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/780,138

(22) Filed: Jul. 19, 2007

(51) Int. Cl. H04Q 7/00

(52) U.S. Cl. 370/328

(57) ABSTRACT

A method in a wireless communication device (200) capable of functioning as a node in an ad hoc network, including switching packet data, received from a source node, to a destination node, determining a switching capacity utilization of the wireless communication device, and re-allocating at least a portion of the packet switching performed by the wireless communication device with another switching node based upon the switching capacity utilization of the wireless communication device.

### FIELD OF THE DISCLOSURE

The present disclosure relates generally to wireless communications, and more particularly to packet switching allocation in ad hoc communication networks.

### BACKGROUND

An ad hoc network is a collection of communication devices that self-organize to form a cooperative communications network. In ad hoc networks, generally, each device, also referred to as a node, has the capability to function as a source of information, a destination for information, and as a relay that forwards information to other nodes or destinations during a communication session. A network device, or node, that functions as a relay is sometimes referred to herein as a switching node. An autonomous ad hoc network is capable of operating without fixed infrastructure, wherein each device functions as an intermediate router to facilitate multiple communication paths thereby extending the transmission range of a communication session through multiple hops. A mesh ad hoc network provides wireless connectivity for fixed infrastructure elements with a gateway interface to one or more wide area networks. Mesh ad hoc networks feature multiple communication paths between elements that may include one or more hops. The fixed infrastructure of mesh ad hoc networks may provide wired or wireless backhaul between elements. A hybrid mesh ad hoc network comprises stationary and mobile devices, fixed infrastructure elements and gateway interfaces. The infrastructure may provide wired or wireless backhaul between ad hoc devices or autonomous ad hoc networks. Hybrid mesh ad hoc networks support networking via single or multiple hops with fixed infrastructure and/or ad hoc capable device connections.

Traffic between nodes in ad hoc networks may vary substantially based on spontaneous changes in network conditions. Such changes include changes in traffic and network configuration, among other conditions. Traffic changes include changes in loading, bandwidth requirements, quality of service (QoS) requirements, and traffic priorities, among other conditions. Network configuration changes include, among others, changes in the number of nodes supported by a switching node, changes in the frequency bands supported by switching nodes and all nodes along the associated communication path, and changes in distances (and corresponding power levels) between nodes. Unexpected or substantial changes in network traffic or configuration may result in dropped or lost packets, which is a typical measure of network reliability. To provide a viable alternative to existing communication networks, for at least some applications, ad hoc networks must reliably accommodate variations in network traffic and configuration.

As broadband traffic stretches the bandwidth limits of spectrum, cognitive radio technology enables opportunistic spectrum sharing. Cognitive technology coupled with ad hoc technology provides almost unlimited spectrum availability. With the coupling of ad hoc and cognitive technologies, the reliability of the network can be enhanced to accommodate variations in network traffic and configuration. Thus in some applications, it is desirable to detect variant network traffic conditions and configurations and reconfigure the network by opportunistically sharing spectrum without dropping connectivity between nodes.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates an ad hoc communications network.

FIG. 2 illustrates a schematic block diagram of a wireless communication device.

FIG. 3 illustrates a process flow diagram.

FIG. 4 illustrates another process flow diagram.

### DETAILED DESCRIPTION

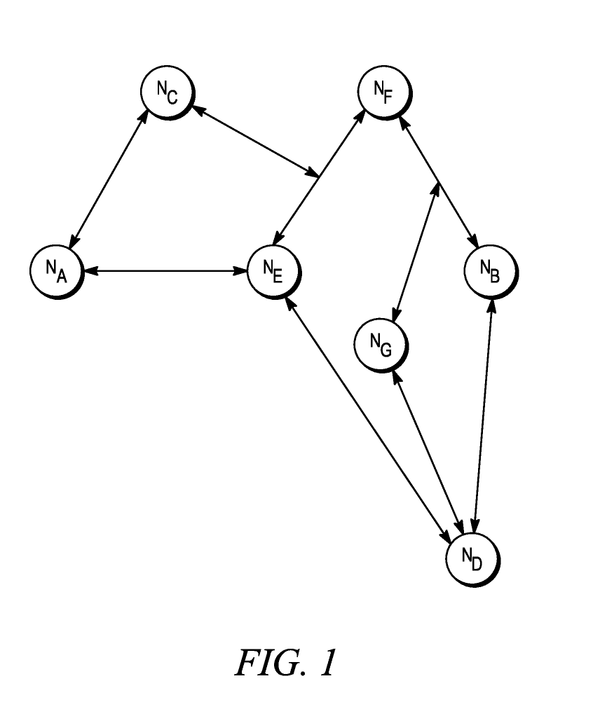

FIG. 1 illustrates a plurality of wireless communication devices capable of self-organizing to form an ad hoc communications network 100 wherein each wireless communication device constitutes a network node. In FIG. 1, for example, the network includes nodes N_{A-G}. Generally, each node is capable of functioning as the originator of a communication, for example, a source of information, a destination for a communication or information, or a relay that forwards a communication or information to one or more other nodes or destinations during a communication session. A node that relays information is also referred to herein as a switching node.

In some embodiments, the ad hoc network is an autonomous network capable of operating without fixed infrastructure, wherein each device functions as an intermediate router, or switching node, to facilitate multiple communication paths thereby extending the transmission range of a communication session through multiple hops. In FIG. 1, for example, nodes N_{A-G} may self organize with or without other nodes to form an autonomous ad hoc network. In another embodiment, the ad hoc network is a mesh network that provides connectivity for fixed infrastructure elements with a gateway interface to one or more other networks including local and wide area networks. For example, nodes N_{A-G} in FIG. 1 may self organize to form an autonomous ad hoc network capable of communicating with a fixed node that communicates with IP network via a gateway. The disclosure is not intended to be limited to the particular network configurations illustrated. The disclosure also contemplates other network configurations including, but not limited to, hybrid mesh ad hoc networks that support networking via single or multiple hops with fixed infrastructure entities and/or ad hoc capable device connections, among other configurations.

A communication device capable of operating as a node in an ad hoc network including networks of the types discussed above, among others, may be a fixed base or mobile communications device. In one embodiment, the communication device is a wireless cellular communication handset, for example, a 3GPP or 3GPP2 compliant device, or a WiMAX communications device, an 802.1x or other WAN or LAN capable communications device, or a combination of communication device capabilities enabling a bridge between networks such as 3GPP and 802.1x. The device may also be embodied as a wireless or wire-line base unit. Generally, the communication devices constituting the network nodes may also be compliant with a combination of these and other open and proprietary communication protocols.

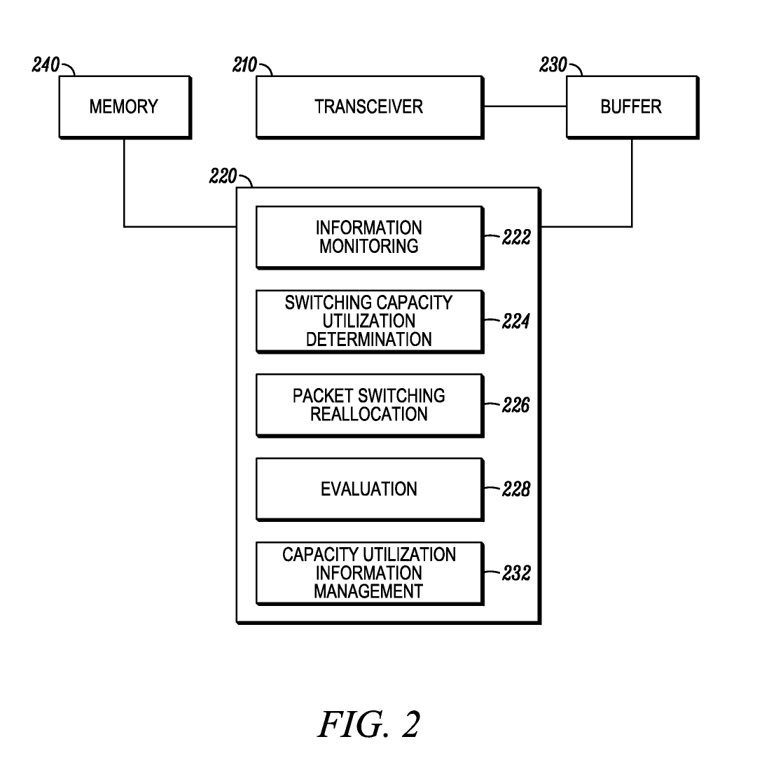

FIG. 2 illustrates a wireless communication device 200 capable of operating as a node in an ad hoc network. The device generally comprises a transceiver 210 communicably coupled to a controller 220. The controller is coupled to memory 240 for storing operating programs and data. The memory may actually comprise various memory devices, for example, ROM, RAM, etc. The controller and transceiver are also coupled to a data buffer 230. In one embodiment, the data buffer is implemented as a high speed data buffer coupled to the controller by a high speed data bus. In another embodiment, more generally, the device comprises a plurality of transceivers coupled to a controller, wherein each transceiver is coupled to a data buffer. Each transceiver is capable of transmitting and receiving on one or more frequency bands, for example, 2.4 GHz unlicensed band and 1.9 GHz licensed band. The controller communicates with the transceiver, memory and buffer via a control channel or bus. These entities are also interconnected by a data bus and an address bus where appropriate. These entities may be integrated in whole or in part, for example, on a common semiconductor substrate. Alternatively, these entities may be embodied as discrete elements or devices. In some embodiments, the communication device, for example, a wireless communication device handset or a portable communication device also includes a user interface. A typical user interface may include audio inputs and outputs, a display interface, a keypad or touch-screen for inputting data or other information and controlling various functions and features typically integrated on a communication device used as a network node. These and other user interface elements are not illustrated but are known generally by those of ordinary skill in the art. Some nodes, for example, some base nodes, may not include a user interface.

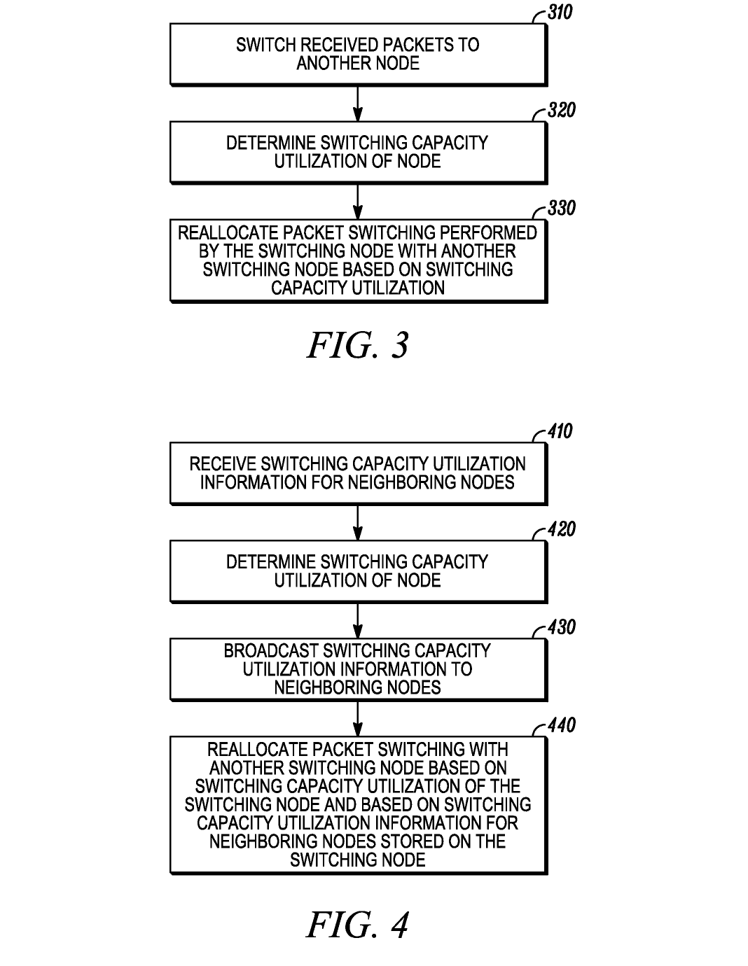

In the process diagram 300 of FIG. 3, at 310, a switching node receives packet data from a source node and forwards, or switches, the packet data to a destination node. In FIG. 1, for example, switching node N_{E} receives packets from node N_{F} and forwards the received packets to one or more other nodes, for example, to node N_{A}. According to one aspect of the disclosure, the controller is configured to determine the switching capacity utilization of the wireless communication device functioning as the switching node in an ad hoc network.

In FIG. 2, the controller is configured to perform a packet switching information monitoring function 222. The information monitored is selected from a group of criteria from which the packet switching capacity utilization of the device may be determined. In one embodiment, the group comprises: fluctuations in switching load at the wireless communication device including the bandwidth requirements of the traffic; the type of traffic switched at or by the wireless communication device; frequency band availability of the wireless communication device; and changes in a configuration of the network within which the switching occurs. In other embodiments, the group comprises other information indicative of the switching capacity utilization of the node. For example, the monitored information may be based upon background evaluations of the availability of current frequency bands and possible alternative frequency bands. The results of these evaluations will be part of the utilization information that are used to make decisions to alter the network configuration by using nodes that are capable of operating in different frequency bands and enabling a transfer of the flow of packets over different routes. The controller is also configured to perform a switching capacity utilization determination function 224 for determining the switching capacity utilization based upon the packet switching information monitored, as suggested. In the exemplary embodiment, the controller determines switching capacity utilization of the wireless communication device based on information selected from the group comprising fluctuations in switching load at the wireless communication device including the bandwidth requirements of the traffic, the type of traffic switched at the wireless communication device, frequency band availability of the wireless communication device, and changes in the configuration of the network within which the switching occurs. In FIG. 3, the switching node determines its switching capacity utilization at 320. The switching capacity utilization of the switching node is determined based on the monitored switching capacity utilization criteria as discussed above in connection with FIG. 2.

In FIG. 2, the controller is configured to perform a packet switching reallocation function 226. The reallocation function serves to reallocate at least a portion of the packet switching performed by the wireless communication device with another switching node based on the switching capacity utilization of the wireless communication device. In some embodiments, the re-allocation is also based on switching capacity utilization information for one or more neighboring nodes as discussed further below. In FIG. 3, this reallocation is performed at 330.

In one embodiment, packet data currently switched by a first switching node is transferred to another switching node when the switching capacity utilization of the first switching node is over-utilized. In FIG. 1, for example, node N_{E} switches packets received from node N_{F} to node N_{A}. In the event that node N_{E} is over-utilized, node N_{E} reallocates at least a portion of its packet switching load to one or more other nodes, for example, to node N_{C}, wherein node N_{c} receives at least a portion of the packets from node N_{F} and switches the received packets to node N_{A}.

In another embodiment, packet data currently switched by a second switching node is transferred to the first switching node when the switching capacity utilization of the first switching node is underutilized. In FIG. 1, for example, node N_{B} switches packets received from node N_{F} to node N_{D}. In the event that node N_{G} is underutilized, node N_{B} reallocates at least a portion of its packet switching load to one or more other nodes, for example, to node N_{G}, wherein node N_{G} receives at least a portion of the packets from node N_{F} and switches the packets to node N_{D}.

In FIG. 2, the controller is configured to perform an evaluation function 228 wherein switching node capacity utilization information for neighboring switching nodes is evaluated. The evaluation is based upon information provided by the neighboring nodes. With this information, a switching node may evaluate the suitability of neighboring nodes for reallocating packet switching loading. Thus, for example, if the switching capacity utilization of a switching node is under-utilized, the switching node may refer to the utilization information for neighboring nodes and select one or more neighboring nodes from which the switching node may obtain packet switching traffic thereby increasing its switching capacity utilization. Where the switching capacity utilization of the switching node is over-utilized, the node may refer to the utilization information for neighboring nodes and select one or more neighboring nodes to which the switching node may transfer packet switching traffic thereby decreasing its switching capacity utilization.

In FIG. 2, switching capacity utilization information for neighboring switching nodes is stored in memory 240. This information generally includes the identity of the neighboring node and corresponding switching capacity utilization information stored in table or in some other form. The switching capacity utilization information may include metrics such as transceiver frequency bands supported by the node, current load estimate for a route as a function of throughput capability for each supported destination for each supported frequency band, traffic processing load of the controller 220, battery level of the node, and a list of the current neighbor nodes with their respective switching capacity utilization information previously received. In one implementation, each node broadcasts its own monitored information to neighboring nodes, which stores the information locally in memory 240. For example, a node may broadcast its utilization information when the node first joins the network. The node may also update its utilization information broadcast after its switching operation assumes a relatively steady state. In other embodiments, the node delays its initial utilization information broadcast until its switching operation assumes a steady state. The nodes may also periodically broadcast updated utilization information, for example, when the capacity utilization changes. The conditions that trigger the node to broadcast updated switching capacity utilization information may be based on a comparison of the switching load with threshold or reference information.

In FIG. 2, the device 200 is configured to perform a capacity utilization information management function 232 wherein the updating and storage of information received from neighboring nodes is managed. Also managed is the broadcasting of capacity utilization information about the switching node to neighboring nodes. Nodes receiving switching capacity utilization broadcast information will update and store this information locally for use as described herein. In implementations where the switching node stores information for a limited number of neighboring nodes, information may be prioritized based on signal strength or based on other criteria regarding the neighboring nodes. Thus the switching node may store utilization information for a select group of neighboring nodes.

Thus each switching node in the network monitors and broadcasts its traffic switching capabilities to the neighboring nodes. In one embodiment, a table entry is created in each switching node for each neighboring node reporting its capabilities. Each switching node then proceeds to monitor the traffic metrics (load, type, and power level) being switched through the node, as part of its normal switching operation. As the switching node monitors the traffic, it compares the load, type and power levels to pre-set thresholds configured in the switch. As suggested, the switching node may be a small mobile unit capable of switching only 1 Mbps, or it may be a mobile gateway capable of switching 10 Mbps. The device may support a range of frequencies within either licensed or unlicensed spectrum. If a node's transceivers support a lower range of frequencies, then it may support a larger coverage area than the nodes that could not support the lower frequency ranges. A switching node that supports a low frequency range could potentially use the lower frequencies to extend their coverage to bypass switches that are near their maximum switching threshold. There are many potential conditions that may cause a switching node to take action including but not limited to over-utilization, under-utilization, and low power level, among others. In one embodiment, the thresholds defining each of these conditions are pre configured into the switching node. Depending on the condition detected by a switching node, the switching node will search its table of switching nodes to see if the traffic characteristics prompting the condition may be more suitably handled by another node.

The function performed by the controller 200 of FIG. 2 may be implemented as software and/or firmware suitable for execution by the controller, which may be implemented as a digital processor. The code may be stored in memory 240. The software or firmware implementation of these functions may be as software modules or functions that configure the processor to perform the corresponding function when the code is executed. In alternative embodiments, these functions may be performed by a hardware equivalent of the exemplary software implementation, or as a combination of hardware and software.

In FIG. 4, at 410, a switching node receives switching node capacity utilization information for one or more neighboring nodes. This information is transmitted from neighboring nodes in a message or other format, the contents of which are stored in the memory of the receiving node. The capacity utilization information for the neighboring nodes is accessible to the controller for use as discussed herein. At 420, the switching node determines its switching capacity utilization based on the monitored criteria, for example, based on fluctuations in switching load at the node including the bandwidth requirements of the traffic; the type of traffic switched at or by the node; frequency band availability of the wireless communication device; and changes in a configuration of the network or environment within which the switching occurs, as discussed above. At 430, the switching node transmits information indicative of its switching capacity utilization. The transmission of switching capacity utilization information by the switching nodes will generally occur periodically, depending on a variety of circumstances including but not limited to changes in the network configuration and changes in the utilization of the particular node. The order of the events in FIG. 4 is not intended to be limited to that illustrated. For example, in FIG. 4, the actions at 420 and 430 may occur before receiving switching capacity utilization information from neighboring nodes at 410. Also, the action at 420 may occur before the action at 410, and the action at 430 may occur after the action at 410.

In FIG. 4, at 440, the switching node reallocates packet switching with one or more neighboring nodes based on the switching capacity utilization information of the switching node and based on switching capacity utilization information about the neighboring nodes. Determining whether the node is being over utilized or under utilized is based generally on a comparison of traffic metrics experienced by the switching node to known thresholds within the switching node. If the node determines that it is being over, or under, utilized, it looks to one or more adjacent nodes from the traffic switching table that has switching capabilities more suitable for the traffic characteristics being currently experienced by the switching node. When a reallocation is desired, the switching node negotiates a link exchange with a neighboring switching node. During the reallocation process, communications to the existing interconnected nodes may be paused before or when performing the link exchange.

If the switching node is being underutilized then it searches for a neighboring node having switching capabilities more suitable to the lower traffic load currently experienced by the switching node. If, and when, such a node is found, the switching nodes may pause or interrupt communications between interconnecting nodes and query the identified node for its traffic characteristics information. If it is determined by the two switching nodes that an exchange of supported links is warranted, then each switching node will pause communications with its connected nodes, and instruct the nodes to switch to the other node, with information such as required frequency, modulation type, and power level.

In another embodiment an under-utilized node may initiate a transfer of links to the under-utilized switching node from adjacent switching nodes that have lower data throughput capabilities, or lower power levels. The under-utilized node may use a lower frequency to access nodes that would otherwise be out of its range, but in the range of the over-utilized switching nodes. In some situations, a subset of links is transferred from the over-utilized switching node to the under-utilized node. Each node will then resume normal operation with its new connections. If a node is over-utilized, then it may also initiate a search for an under-utilized node to exchange switching responsibilities with the under-utilized node, using the same method described above. This process continues throughout the life of the network, attempting to enhance the reliability of the network.

The result is that the switching nodes will exchange or transfer a subset of their supported nodes (nodes for which they are switching data) in order to enhance the reliability of the network. By measuring the resources available on the switching node, the switching node may develop a set of switching thresholds that would be used to compare against the actual switching metrics of the node. If the data switching metrics indicate that the switching node is over-utilized (high threshold) or under-utilized (low threshold) the switching node may negotiate an exchange of all, or a subset of links, from adjacent nodes. The intent will be to adjust the actual switching metrics away from the threshold.

In another embodiment, the link transfer responsibility may be initiated by switching nodes on behalf of a node that no longer has the ability to reallocate traffic. An example of this is a switching node that has exited the network. A node may exit the network for various reasons, such as being powered off, or for roaming out of range of the network. This is a normal and acceptable scenario in ad hoc networks. In this case, the switching nodes connected to the exited node must analyze the link capacity information of the remaining nodes and reallocate the network traffic to the other nodes based on the link capacity information previously transmitted by those nodes. For example, in FIG. 1, if node N_{G} exited the network, then switching node N_{F} would have to reallocate the network traffic to nodes N_{E} and N_{B} according to the latest switching capacity information received from the nodes.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device capable of functioning as a node in an ad hoc network, the method comprising:
switching packet data, received from a source node, to a destination node;
determining a switching capacity utilization of the wireless communication device;
re-allocating at least a portion of the packet switching performed by the wireless communication device with another switching node based upon the switching capacity utilization of the wireless communication device.

2. The method of claim 1, reallocating at least a portion of the packet switching performed by the wireless communication device includes transferring the switching of packet data switched by the wireless communication device to another switching node, wherein the switching of packet data performed by the wireless communication device is reduced.

3. The method of claim 1, reallocating at least a portion of the packet switching performed by the wireless communication device includes transferring the switching of packet data switched by another switching node to the wireless communication device, wherein the switching of packet data performed by the wireless communication device is increased.

4. The method of claim 1, identifying another switching node with which packet switching performed by the wireless communication device may be reallocated based on the switching capacity utilization of the wireless communication device and based on switching capacity utilization information about neighboring nodes.

5. The method of claim 4,
determining that a switching capacity of the wireless communication device is over-utilized based on the switching capacity utilization of the wireless communication device,
reallocating at least a portion of the packet switching performed by the wireless communication device by transferring the switching of packet data currently switched by the wireless communication device to another switching node, wherein the switching of packet data performed by the wireless communication device is reduced.

6. The method of claim 5, reallocating at least a portion of the packet switching performed by the wireless communication device by transferring the switching of packet data currently switched by the wireless communication device to other switching nodes operating on an alternate frequency band.

7. The method of claim 4,
determining that a switching capacity of the wireless communication device is underutilized based on the switching capacity utilization of the wireless communication device,
reallocating at least a portion of the packet switching performed by the wireless communication device by transferring the switching of packet data currently switched by another switching node to the wireless communication device, wherein the switching of packet data performed by the wireless communication device is increased.

8. The method of claim 7, reallocating at least a portion of the packet switching performed by the wireless communication device by transferring the switching of packet data currently switched by the wireless communication device to other switching nodes operating on an alternate frequency band.

9. The method of claim 1,
receiving switching capacity information for neighboring switching nodes,
identifying another switching node with which the wireless communication device may reallocate packet switching based on the switching capacity information for the neighboring switching nodes.

10. The method of claim 1, transmitting switching capacity information about the wireless communication device to neighboring switching nodes.

11. The method of claim 1, determining the switching capacity utilization of the wireless communication device based on information selected from the group comprising: fluctuations in switching load at the wireless communication device including the bandwidth requirements of the traffic, type of traffic switched at the wireless communication device, frequency band availability of the wireless communication device, and changes in a configuration of the network within which switching occurs.

12. A wireless communication device capable of functioning as a switching node in an ad hoc network, the device comprising:
a transceiver;
a controller coupled to memory and to the transceiver,
the controller configured to determine packet switching capacity utilization of the wireless communication device,
the controller configured transfer the switching of packet data currently switched by the wireless communication device to another switching node when the switching capacity utilization of the wireless communication device over-utilized,
the controller configured to transfer the switching of packet data currently switched by another switching node to the wireless communication device when the switching capacity utilization of the wireless communication device underutilized.

13. The device of claim 12,
switching capacity utilization information about neighboring nodes stored in memory,
the controller configured to identifying another switching node with which packet switching performed by the wireless communication device may be reallocated based on the switching capacity utilization of the wireless communication device and based on the switching capacity utilization information about the neighboring nodes.

14. The device of claim 12, the controller configured to cause the transceiver to transmit switching capacity information about the wireless communication device to neighboring switching nodes.

15. The device of claim 12,
the controller configured to monitor information selected from the group comprising: fluctuations in switching load at the wireless communication device, type of traffic switched at the wireless communication device, and changes in a configuration of the network within which switching occurs,
the controller configured to determine the switching capacity utilization of the wireless communication device based on information monitored.

16. The device of claim 12,
the controller configured to store switching capacity utilization information received from neighboring nodes in the memory,
the controller configured to identify another switching node with which packet switching performed by the wireless communication device may be reallocated based on the switching capacity utilization information stored in memory.

17. A method in a node that switches data packets in an ad hoc network, the method comprising:
receiving a message from neighboring nodes, each message including frequency band information supported by each of the corresponding neighboring nodes;
instructing the source node to send packets to at least one neighboring node based upon the frequency band information supported by the neighboring node.
